(19) United States
(12) Patent Application Publication
(10) Pub. No.: US 2014/0220219 A1
(43) Pub. Date: Aug. 7, 2014

(54) Flavorless Mustard Paste

(71) Applicant: WISCONSIN SPICE, INC., Berlin, WI (US)

(72) Inventors: Allen Phillip Sass, Neenah, WI (US); Karl Arlin Spiegelberg, Green Bay, WI (US); Phillip Joseph Sass, Berlin, WI (US); Citra Putri Rahardjo, Oshkosh, WI (US)

(73) Assignee: WISCONSIN SPICE, INC., Berlin, WI (US)

(21) Appl. No.: 13/760,906

(22) Filed: Feb. 6, 2013

(51) Int. Cl. A23L 1/39

(52) U.S. Cl. CPC A23L 1/39
USPC 426/589

(57) ABSTRACT

A flavorless mustard paste without a noticeable flavor and a method of manufacturing the same, including a mustard seed and acidic liquid solvent, where the resultant paste has less than 100 mg/dl glucose and a substantially stable pH value of less than 5.5. The flavorless mustard paste according to this invention may retain the functional benefits of viscosity-building, texture-aiding, and emulsion-strengthening.

### FIELD OF THE INVENTION

The present invention generally is directed to a mustard paste, and more particularly, relates to a mustard paste providing an increased viscosity and/or decreased flavor. The invention additionally relates to a method of manufacturing the same.

### BACKGROUND OF THE INVENTION

Traditional prepared mustards, and/or mustard pastes, are used as a condiment, and just as commonly are used as ingredients in sauces, dressings, and the like. These are typically formed from an aqueous suspension of mustard seeds in water and vinegar. Salts and spices may also be added to taste. Prepared mustards, and more generally mustard pastes, are milled so as to extract mucilage, the material responsible for creating viscosity and texture. Mustard pastes high in mustard seed concentration are commonly used in sauces and dressings to help strengthen emulsions and build texture, often times serving as a replacement to soybean and/or canola oils in high-fat containing dressings and sauces, such as mayonnaise. While mustard pastes may be included in these products for its functional benefits, namely viscosity-building, texture-aiding, and emulsion-strengthening attributes, commercially available products often still possess the taste consistent with traditional prepared mustards. While the flavor profile may alter with the type of mustard seed used in formulation, the traditional mustard flavor used in functional mustard pastes is derived from yellow mustard seed (S. alba or B. hirta). The flavor development associated with yellow mustard seed, when used in prepared mustards and/or mustard pastes, can be described by the following reaction:

Sinalbin+Water→p-Hydroxybenzyl Isothiocyanate+Glucose+Sinalpine Acid Sulfate

This reaction is catalyzed by an enzyme, namely Myrosinase, which is naturally occurring in yellow mustard seed. The glucosinolate, particularly Sinalbin, is also naturally occurring in yellow mustard seed, and reacts with water, in the presence of Myrosinase, which creates the products on the right-hand side of the reaction depicted above. p-Hydroxybenzyl Isothiocyante (“Isothiocyanate”) is the aromatic compound primarily responsible for the traditional flavor associated with prepared yellow mustard and/or mustard pastes. Glucose and Sinalpine Acid Sulfate (“Acid”), while products of the flavor reaction, are considered minor products; however, the development of Glucose and/or Acid may be used as indicators for the successful completion of the reaction, and thus may be used to indicate the presence of the Isothiocyanate, or more generally “mustard flavor”.

When prepared mustards and/or mustard pastes are used as ingredients primarily for its functional benefits it is often desirable to form an aqueous mustard paste that is absent of Isothiocyanate, or more generally—mustard flavor. Prior attempts to substantially remove the mustard flavor have included attempts to deactivate the Myrosinase enzyme while it is in its dry or solid mustard seed form, i.e., prior to forming an aqueous mustard paste, resulting in what is commonly referred to as “deactivated” or “deheated” mustard seed. “Deactivated” or “deheated” mustard seed simply refers to mustard seed that, as a result of Myrosinase deactivation, is unable to generate the products on the right-hand side of the Sinalbin degradation equation described above, most notably the Isothiocyanate, or mustard flavor. However, in adding “deactivated” or “deheated” mustard seed to solvents, including water and vinegar, it has been found that the reaction, while delayed, still occurs. Accordingly, the food industry is yet to be met with a prepared mustard and/or mustard paste which demonstrates the preferred functional characteristics in the absence of “mustard flavor”.

Thus, there is a need for formulation and processing parameters that ensure “deheated” mustard seed, when used in prepared mustards and/or mustard pastes includes the desired functionality, but lacks a strong mustard flavor.

### SUMMARY OF THE INVENTION

Illustrative embodiments according to the invention are directed towards an aqueous mustard paste including yellow mustard seed and vinegar, where the concentration of glucose in the paste is less than approximately 100 mg/dl serving as measurable proof that the mustard flavor reaction forming Isothiocyanate has not occurred. Additionally, the aqueous mustard paste should demonstrate a stable or consistent pH, and preferably a stable or consistent pH of less than 5.5, which provides additional measureable evidence that neither Sinalpine Acid Sulfate nor Isothiocyanate, i.e., mustard flavor, is present in the aqueous mustard paste.

In one aspect, the invention relates to an aqueous mustard paste including yellow mustard seed and vinegar, having a concentration of Isothiocyanate at levels undetectable by qualitative flavor evaluation.

In another aspect, the invention includes an acidic liquid of preferably not less than 12% titratable acidity, such as a 120 grain strength vinegar, to which yellow mustard seed is added.

In another aspect, the invention relates to flavorless aqueous mustard paste that is substantially free of an isothiocyanate and includes a volume of ground mustard seed and a volume of an acidic liquid.

In yet another aspect of the invention, the acidic liquid may contain acetic acid, citric acid, phosphoric acid, or sodium acid sulfate

In another aspect, the invention includes a deheated yellow mustard seed.

In still another aspect, the invention includes a method of manufacturing a flavorless aqueous mustard paste having a constant pH value of less than 5.5 and a concentration of glucose less than 100 mg/dl providing the steps of combining a volume of mustard seed and a volume of an acidic liquid and milling the volume of mustard seed and the volume of acidic liquid to form the flavorless aqueous mustard paste.

Numerous other aspects, features, and advantages of the present invention will be made apparent from the following detailed description together with the drawing figures.

### BRIEF DESCRIPTION OF THE DRAWINGS

The disclosed embodiments will be further explained with reference to the attached drawings, wherein like structures are referred to by like numerals throughout the several views. The drawings are not necessarily to scale, the emphasis having instead been generally placed upon illustrating the principles of the invention and the disclosed embodiments.

FIG. 1 shows a method of forming a flavorless mustard paste in accordance with at least one embodiment of the present invention.

### DETAILED DESCRIPTION OF THE INVENTION

Illustrative embodiments according to the invention are directed towards an aqueous mustard paste. More specifically, particular illustrative embodiments described herein are directed towards a substantially flavorless mustard paste, and a method of manufacturing the same.

In one embodiment of the current invention, an aqueous mustard paste may be formed from a suspension of yellow mustard seed in vinegar as follows below in Table 1. While the weight and percent weight of those ingredients identified in the following table may constitute a preferred embodiment, the indicated range in percent weight of each ingredient is also considered within the scope of this invention.

TABLE 1

| Ingredient | Grams | Percent weight | Range in percent weight |
|---|---|---|---|
| Mustard Seed | 30.0 | 20.8 | 15-30% |
| Vinegar | 114.0 | 79.2 | 70-85% |

While traditional aqueous mustard pastes are manufactured by means of initially combining mustard seeds in a volume of water, the inventors have identified that this step may result in the undesirable activation of the Myrosinase enzyme. While this is true of unaltered raw mustard seeds, it is also true of deheated mustards. Accordingly, the inventors have identified a method of manufacturing an aqueous mustard paste that substantially inhibits the activation of the Myrosinase enzyme once the mustard seed is placed into liquid suspension.

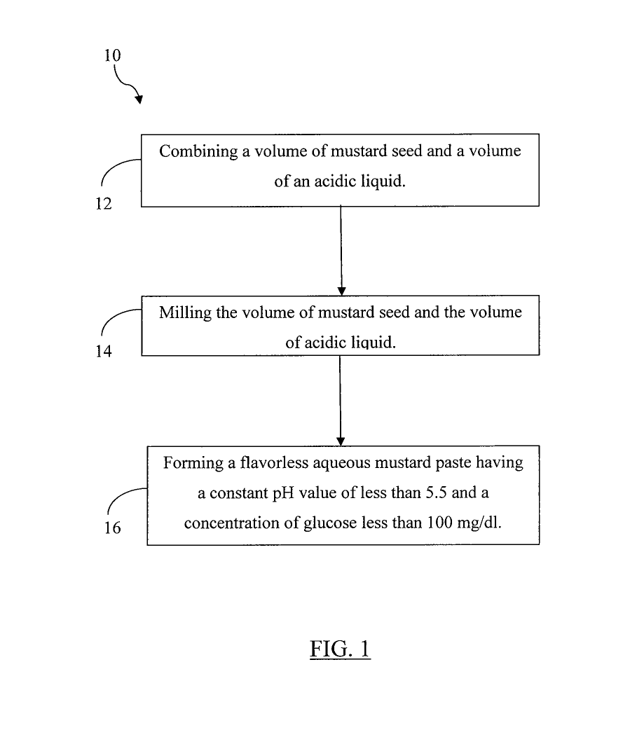

Namely, an aqueous mustard paste according to the general formulation listed in Table 1 may be formed in one embodiment in accordance with the method 10 depicted in FIG. 1. Initially, the mustard seed and the volume of an acid liquid, such as vinegar, are combined, as seen in block 12. In one embodiment, the vinegar may be 120 grain vinegar, i.e., contained 12% acetic acid. However, higher acid concentrations in the solvent are also considered within the scope of this invention. In an alternative embodiment, the solvent may include an alternative acid solution, including preferably a food grade acid such as citric acid, phosphoric acid, sodium acid sulfate, etc. The concentration of such acid solutions may vary as is necessary to inhibit the activation of the Myrosinase enzyme. After these ingredients are combined, they are milled together as shown in block 14. A flavorless aqueous mustard paste is formed as a result of the milling process, as is shown in block 16. It is thought that the presence of the vinegar interferes with and inhibits the activation of the Myrosinase enzyme as to prevent the hydrolysis of the glucosinolate sinalbin; however, the present invention is in no way limited to this mode of operation.

After milling the mustard seed and vinegar together to form an aqueous mustard paste, glucose tests were conducted over a period of 24 hours. As glucose is a product of sinalbin hydrolysis via the myrosinase enzyme, the presence of glucose provides an effective quantitative indication of myrosinase activity. In one embodiment of the current invention, multiple glucose tests were administered to both the aqueous mustard paste according to the formulation specified in Table 1 and an aqueous mustard paste in which 16.6% of the vinegar was replaced with water.

According to these glucose tests, the results of which are provided below in Table 2, positive results indicate a glucose level of greater than 100 mg/dl, i.e., 0.1%, while negative results indicate of glucose level of less than 100 mg/dl, i.e., 0.1%. In Table 2, below “V” stands for vinegar, “S” stands for seed, and “W” stands for water. The term “V+S+W after 5 minutes” means that water is added five minutes after the vinegar and seed were mixed together. The term “V+S+W after 10 minutes” means that the water is added 10 minutes after the vinegar and seed were mixed together. The term “V+S+W after 15 minutes” means that the water is added 15 minutes after the vinegar and seed were mixed together.

TABLE 2

| | | | | | | Glucose | Glucose | | | |
|---|---|---|---|---|---|---|---|---|---|---|
| | | | | | Acidity | Present | Present | Results | Results | Results |
| | | | | | from | After | After | After | After | After |
| Prototype | Seed | Vinegar | Water | Vinegar | Vinegar | Adding | Adding | 2.5 | 18 | 24 |
| Results | (g) | (g) | (g) | Grain | (%) | Vinegar | Water | hours | hours | hours |
| A (V + S) | 30 | 38 | − | 120 | 6.71 | − | − | + | + | + |
| A (V + S + W | 30 | 38 | 76 | 40 | 3.17 | − | − | + | + | + |
| after 5 | | | | | | | | | | |
| minutes) | | | | | | | | | | |
| A (V + S + W | 30 | 38 | 76 | 40 | 3.17 | − | − | + | + | + |
| after 10 | | | | | | | | | | |
| minutes) | | | | | | | | | | |
| A (V + S + W | 30 | 38 | 76 | 40 | 3.17 | − | − | + | + | + |
| after 15 | | | | | | | | | | |
| minutes) | | | | | | | | | | |
| B (V + S) | 30 | 57 | − | 120 | 7.86 | − | − | + | + | + |
| B (V + S + W | 30 | 57 | 57 | 60 | 4.75 | − | − | + | + | + |
| after 5 | | | | | | | | | | |
| minutes) | | | | | | | | | | |
| B (V + S + W | 30 | 57 | 57 | 60 | 4.75 | − | − | + | + | + |
| after 10 | | | | | | | | | | |
| minutes) | | | | | | | | | | |
| B (V + S + W | 30 | 57 | 57 | 60 | 4.75 | − | − | + | + | + |
| after 15 | | | | | | | | | | |
| minutes) | | | | | | | | | | |
| C (V + S) | 30 | 76 | − | 120 | 8.60 | − | − | − | + | + |
| C (V + S + W | 30 | 76 | 38 | 80 | 6.33 | − | − | − | + | + |
| after 5 | | | | | | | | | | |
| minutes) | | | | | | | | | | |
| C (V + S + W | 30 | 76 | 38 | 80 | 6.33 | − | − | − | + | + |
| after 10 | | | | | | | | | | |
| minutes) | | | | | | | | | | |
| C (V + S + W | 30 | 76 | 38 | 80 | 6.33 | − | − | − | + | + |
| after 15 | | | | | | | | | | |
| minutes) | | | | | | | | | | |
| D (V + S) | 30 | 95 | − | 120 | 9.12 | − | − | − | − | − |
| D (V + S + W | 30 | 95 | 19 | 100 | 7.93 | − | − | − | + | + |
| after 5 | | | | | | | | | | |
| minutes) | | | | | | | | | | |
| D (V + S + W | 30 | 95 | 19 | 100 | 7.93 | − | − | − | + | + |
| after 10 | | | | | | | | | | |
| minutes) | | | | | | | | | | |
| D (V + S + W | 30 | 95 | 19 | 100 | 7.93 | − | − | − | + | + |
| after 15 | | | | | | | | | | |
| minutes) | | | | | | | | | | |
| E (V + S) | 30 | 114 | − | 120 | 9.50 | − | − | − | − | − |

Referring to Table 2, the first trial using the “deheated” mustard seed instead of regular mustard seed was conducted. According to the experimental protocol, each step was tested properly and all tests indicated that the aqueous mustard paste produced was successfully deheated and indicated no flavor development immediately following the addition of vinegar and water. However, after 2.5 hours, the aqueous mustard paste started to show the development of flavor, detected by the positive result of the glucose test. Thus, additional experiments were conducted. To ensure that the glucose test is accurate, several regular dry ground mustard products were tested as a control group. All of these results indicated immediate glucose production, which shows that the glucose test is a valid test to be used in this product development.

As shown in Table 2, an experiment was then conducted to determine whether the vinegar concentration will prevent the Myrosinase enzymatic reaction from occurring. Still referring to Table 2, the findings prove that the level of vinegar concentration is critical to prevent the activation of the Myrosinase enzymatic reaction.

Accordingly, as indicated in Table 2, the aqueous mustard paste according to the formulation specified in Table 1, which is listed as prototype E in Table 3, produced no discernible glucose, i.e., less than 100 mg/dl, i.e., 0.1%, over a course of 24 hours. This lack of glucose indicates that myrosinase enzyme has not been activated, thereby quantitatively confirming that the aqueous mustard paste accordingly to an embodiment of the present invention is substantially flavorless. The substantially flavorless nature of this aqueous mustard paste was then further confirmed by means of qualitative verification.

In another embodiment of the current invention, an aqueous mustard paste may be formed from a suspension of deheated yellow mustard seed in vinegar as follows below in Table 3. While the proportions of those ingredients identified in the following table may constitute a preferred embodiment, the indicated range in percent weight of each ingredient is also considered within the scope of this invention.

TABLE 3

| Ingredient | Grams | Percent weight | Range in percent weight |
|---|---|---|---|
| Deheated Mustard | 30.0 | 15.0% | 12-30% |
| Seed | | | |
| Vinegar 120 grain | 170.0 | 85.0% | 70-88% |

In one embodiment, the mustard seed may include a deheated yellow mustard seed. The method of forming an aqueous mustard paste containing deheated mustard may include the initial step of exposing the mustard seed to elevated temperatures and/or pressures resulting in the inactivation of the myrosinase enzyme. In one embodiment, exposure to pressure of approximately 100 to 150 kPa for a period of 10.0 to 15.0 minutes may result in the inactivation of the myrosinase. After deheating, the mustard is then ground and combined with a volume of vinegar. In one embodiment, the vinegar may be 120 grain vinegar, i.e., contained 12% by weight acetic acid. After these ingredients are combined, they are milled together to form an aqueous mustard paste.

The aqueous mustard paste as described in Table 3 was shown to have an initial pH of approximately less than 3.5. After a period of 24 hours, the aqueous mustard paste as described in Table 3 was shown to have a maintained stable or consistent pH of approximately less than 3.5. This is evidence that the enzymatic reaction was prevented from occurring; otherwise, a drop in pH would be expected as a result of the acid produced by the reaction.

The aqueous mustard paste as described in Table 3 was shown to have an initial glucose level of less than 0.1%. After 2.5, 18 and 24 hours, the glucose level remained at less than 100 mg/dl, i.e., 0.1%. This is additional supporting evidence that the enzymatic reaction did not take place.

The aqueous mustard paste as described in Table 3 was further shown to maintain its functional characteristics while being substantially flavorless, i.e., substantially free of isothiocyanate.

Certain embodiments according to the invention have been disclosed. These embodiments are illustrative of, and not limiting on, the invention. Other embodiments, as well as various modifications and combinations of the disclosed embodiments, are possible and are within the scope of this disclosure. Various other embodiments of the present invention are contemplated as being within the scope of the filed claims particularly pointing out and distinctly claiming the subject matter regarded as the invention.

1. A flavorless aqueous mustard paste comprising:
a volume of mustard seed;
a volume of vinegar;
a concentration of glucose less than 100 mg/dl; and
the flavorless aqueous mustard paste having a substantially stable pH value of less than 5.5.

2. The flavorless aqueous mustard paste of claim 1, that is substantially free of an isothiocyanate.

3. The flavorless aqueous mustard paste of claim 2, wherein the isothiocyanate is p-hyrdroxybenzyl isothiocyanate.

4. The flavorless aqueous mustard paste of claim 1, wherein the vinegar is formed of at least 12 percent acetic acid.

5. The flavorless aqueous mustard paste of claim 1, having a substantially stable pH value of less than 3.5.

6. The flavorless aqueous mustard paste of claim 1, wherein the mustard seed is deheated mustard seed.

7. A flavorless aqueous mustard paste comprising:
a volume of ground mustard seed;
a volume of a liquid; and
the flavorless aqueous mustard paste being substantially free of an isothiocyanate.

8. The flavorless aqueous mustard paste of claim 7, wherein the isothiocyanate is p-hyrdroxybenzyl isothiocyanate.

9. The flavorless aqueous mustard paste of claim 7, having a substantially stable pH value of less than 5.5.

10. The flavorless aqueous mustard paste of claim 7, further comprising a concentration of glucose less than 100 mg/dl.

11. The flavorless aqueous mustard paste of claim 7, wherein the liquid is formed of at least 12 percent of an acid.

12. The flavorless aqueous mustard paste of claim 11, wherein the acid is selected from a group consisting of acetic acid, citric acid, phosphoric acid, and sodium acid sulfate.

13. The flavorless aqueous mustard paste of claim 7, wherein the mustard seed is deheated mustard seed.

14. A method of manufacturing a flavorless aqueous mustard paste, comprising the steps of:
combining a volume of mustard seed and a volume of an acidic liquid;
milling the volume of mustard seed and the volume of acidic liquid to form a flavorless aqueous mustard paste having a constant pH value of less than 5.5 and a concentration of glucose less than 100 mg/dl.

15. The method of claim 14, wherein the ground mustard seed is a deheated ground mustard seed.

16. The method of claim 14, wherein the flavorless aqueous mustard paste is substantially free of an isothiocyanate.

17. The method of claim 16, wherein the isothiocyanate is p-hyrdroxybenzyl isothiocyanate.

18. The method of claim 14, wherein the acidic liquid is formed of at least 12 percent of an acid.

19. The method of claim 18, wherein the acid is selected from a group consisting of acetic acid, citric acid, phosphoric acid, and sodium acid sulfate.

20. The method of claim 14, wherein the acidic liquid is a 120 grain vinegar.
